(19) United States
(12) Patent Application Publication
(10) Pub. No.: US 2020/0134691 A1
(43) Pub. Date: Apr. 30, 2020

(54) Insurance Plan Rating and Ranking System

(71) Applicant: Michael Wiseman, SR., Corydon, IN (US)

(72) Inventor: Michael Wiseman, SR., Corydon, IN (US)

(21) Appl. No.: 16/176,182

(22) Filed: Oct. 31, 2018

(51) Int. Cl. G06Q 30/06; G06Q 40/08

(52) U.S. Cl. CPC G06Q 30/0629; G06Q 30/0633; G06Q 40/08; G06Q 30/0627

(57) ABSTRACT

The present development is a system for ranking and rating competing healthcare insurance options available in a marketplace based on metrics relevant to an enrollee or patient.

### BACKGROUND/FIELD

The embodiments of the technology relate, in general to systems for aiding in healthcare or other insurance policy selection and sorting prior to enrollment, and in particular to electronic systems for collating presently disparate and voluminous data sources relating to the function of various healthcare insurance products, processing said data in a manner that is relevant to the user, and displaying the results of those operations to the potential enrollee or his insurance agent in a manner that is easily understandable, relevant, and actionable.

### SUMMARY

According to certain embodiments of the present disclosure, an interactive computer system for building a simultaneous display of two or more health insurance plans that reflect the character of an enrollee comprising providing a computer system which performs the steps of; a. receiving from a user qualitative inputs regarding an enrollee's healthcare preferences; b. receiving from a user qualitative inputs regarding the ranked relative importance of the elements from (a) for the enrollee; c. receiving from an automated system quantitative inputs related to the user's prior or current behavior as it pertains to insurance usage; d. receiving from an automated system quantitative inputs regarding regionally available healthcare plans; e. receiving from an automated system healthcare plan documents for at least 2 preceding years for the plans listed in d; f. evaluating the documents from (e) for changes in at least two of previous years to at least two of cost share, provider network drug formulary, utilization management criteria, government ratings including star ratings, average yearly changes to 3rd party ratings, recent network changes; g. generating, based on (f), relative stability scores for each plan; h. generating, based on (a), (b), and (c) a set of criteria affecting the suitability of plans for a user; i. generating a list based on the outputs of the (g) and (h), a list of plans suitable for a user as well as their respective stability scores.

According to further embodiments of the present disclosure, the user preferences from step (a) include at least two of, the medical providers used by an enrollee, requirements regarding utilitization management including prior authorization, quantity limits, step rules, and therapy requirements, pre and post treatment procedures guidelines, relationship of plan costs to deductibles, presence of pharmaceuticals or devices on an insurance formulary, plan treatment of predictable and unpredictable costs, level of engagement required by the enrollee for participation in plan features, and additional plan benefits.

According to further embodiments of the present disclosure, the quantitative inputs from step (c) include at least one of past claim or event data, healthcare providers utilized by the enrollee, healthcare services utilized by the enrollee, healthcare facilities utilized by the enrollee, and enrollee's financial information.

According to further embodiments of the present disclosure, the quantitative inputs regarding appropriate healthcare plans from step (d) include at least one of, participating provider data, plan costs, plan benefits.

According to further embodiments of the present disclosure, the system dynamically generates descriptive language for each plan within the list in step (g), wherein the features of each plan are described to a user in terms responsive to at least one of, the user's stated preferences, impact that plan choice would have had on specific past events, and plan stability.

According to certain embodiments of the present disclosure, an interactive computer system for assisting a user to build a simultaneous display of two or more health insurance plans that reflects the character of an enrollee comprises providing a computer interface which performs the steps of; a. receiving from a user qualitative inputs regarding the enrollee's healthcare preferences; b. receiving from a user qualitative inputs regarding the ranked relative importance of the elements from (a); c. receiving from an automated system quantitative inputs related to the enrollee's prior or current behavior as it pertains to insurance usage; d. receiving from an automated system quantitative inputs regarding regionally available healthcare plans; h. generating, based on (a), (b), and (c) a set of criteria affecting the suitability of plans for an enrollee; i. generating a list based on the outputs of the (d), a list of plans suitable for a user as well as their respective stability scores; j. generating based on (a), (c), and (i) natural language “positioning statements” that link plan features and benefits in terms of the enrollee and patient's actual usage and stated priorities.

### BRIEF DESCRIPTION OF THE FIGURES

The present disclosure will be more readily understood from a detailed description of some example embodiments taken in conjunction with the following figures.

FIG. 1 shows a system-level flow chart of the overall process flow in an embodiment of the present disclosure.

FIG. 2 shows a flow chart of the process by which the system determines provider information from electronic medical records.

FIG. 3 shows a flow chart of the process by which the system determines DME information from electronic medical records and health insurer data.

FIG. 4 shows a flow chart for the process by which the system determines procedure and facility information from electronic medical record and health insurer data.

FIG. 5 is a flow chart for the process by which the system determines prescription information from electronic medical records and insurer data.

FIG. 6 shows a flow chart for the process by which the system determines relative stability of various healthcare plans.

FIG. 7 shows a flow chart for the process by which the system determines relative plan rankings.

FIG. 8 shows a flow chart for the process by which the system determines “positioning” statements as a result of the outputs of the preceding steps of the process.

FIG. 9 shows a prior art method for determining plan priorities without subjective questioning.

FIG. 10 shows a flow chart for how plan choices are ranked based on subjective questioning.

### DETAILED DESCRIPTION

Various non-limiting embodiments of the present disclosure will now be described to provide an overall understanding of the principles of the structure, function, and use of the insurance rating and ranking systems disclosure herein. One or more examples of these non-limiting embodiments are illustrated in the accompanying drawings in terms of both functional flow charts for individual processes within the system and exemplary user interfaces which an operator interacts with to input information or retrieve results from the system. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” one embodiment,” “some example embodiments,” “one example embodiment,” or “an embodiment” means that a particular feature, structure or characteristic described in connection with any embodiment included in at least one embodiment. Thus, appearances of the phrases “in various embodiments,” “in some embodiments,” “in one embodiment,” “some example embodiments,” one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these apparatuses, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can organize and analyze collections of data and documents too large for any insurance agent, social worker, or enrollee to comprehend on their own and output actionable data therefrom. These function effectively as a tool for participants in various levels of the healthcare insurance plan selection process where decisions would otherwise be made based on limited and often irrelevant information.

A hardware and software based standalone system or client-server system can execute software for the system as described in more detail below. A mobile based tablet, phone, or computer system can run on any suitable computing system, a web-based computing system, such as a dedicated server, a user computer or server, multiple computers, a collection of networked computers, a cloud-based computer system, a web-based computer system, or from a storage device, for example. One or multiple processing units, such as central processing units may perform instructions stored in memory to execute the processes described herein.

A hardware and software based system in accordance with the present disclosure can be access via any suitable technique such as a web-browser such as SAFARI, OPERA, GOOGLE CHROME, INTERNET EXPLORER, FIREFOX, or the like executing on a client device. In some embodiments, the systems and methods described herein can be a web-based application, mobile-based application, or a stand-alone executable. Additionally, in some embodiments, the systems and methods described herein can integrate with various types of mobile systems such as Android, IOS, web based applications, and the like. Any suitable device can be used to access, or execute, the computing system, such as laptop computers, desktop computers, smart phones, tablet computers, gaming systems, and the like.

Interaction with the system may include, without limitation, keyboard entry, writing from pen, stylus, finger, or the like, with a computer mouse, or other forms of input (voice recognition, fingerprint recognition, motion sensor recognition, etc.). The user interface for insurance plan rating and ranking may be presented on a tablet, desktop, phone, board, external screen, or paper. In one embodiment, the user may interact with a tablet by writing with a smart pen on normal paper, modified paper, or a hard flat surface of their preference. In this embodiment, the user may receive real-time feedback, or at least near real-time feedback, or may synchronize with a backend database and computer system at a later date. The computer system can be a personal computer, one or multiple computers in a server-type system.

User interaction with the system may take place in any of a variety of operational environments, such as a work setting or a home setting, with one or more users capable of interacting with the system at a given time.

In the present specification, there are four user roles which may be performed by one or more people. Specifically, a “user” is the person who interacts with the system to both enter information, select appropriate data stores to engage for a given queries, and executes the query upon the system. These queries and information are all focused on helping the “enrollee,” or person seeking insurance coverage select the insurance plan which is the best fit for their needs and preferences. Where the term “patient” is used in the present specification and figures, it should be understood to be the enrollee, one of the enrollee's dependents, or alternatively one of the enrollee's staff members who shall be receiving healthcare coverage under the contemplated policies. Finally, the “agent” is the person who communicates the outputs of the system to the enrollee to help them in making their insurance plan decision. Examples of users and agents include insurance agents or brokers, call center employees, social workers, and human resources staff tasked with supporting the enrollee. Similarly, in a self-serve environment, the enrollee may perform the roles of the user, agent, patient, and enrollee with the help of the system.

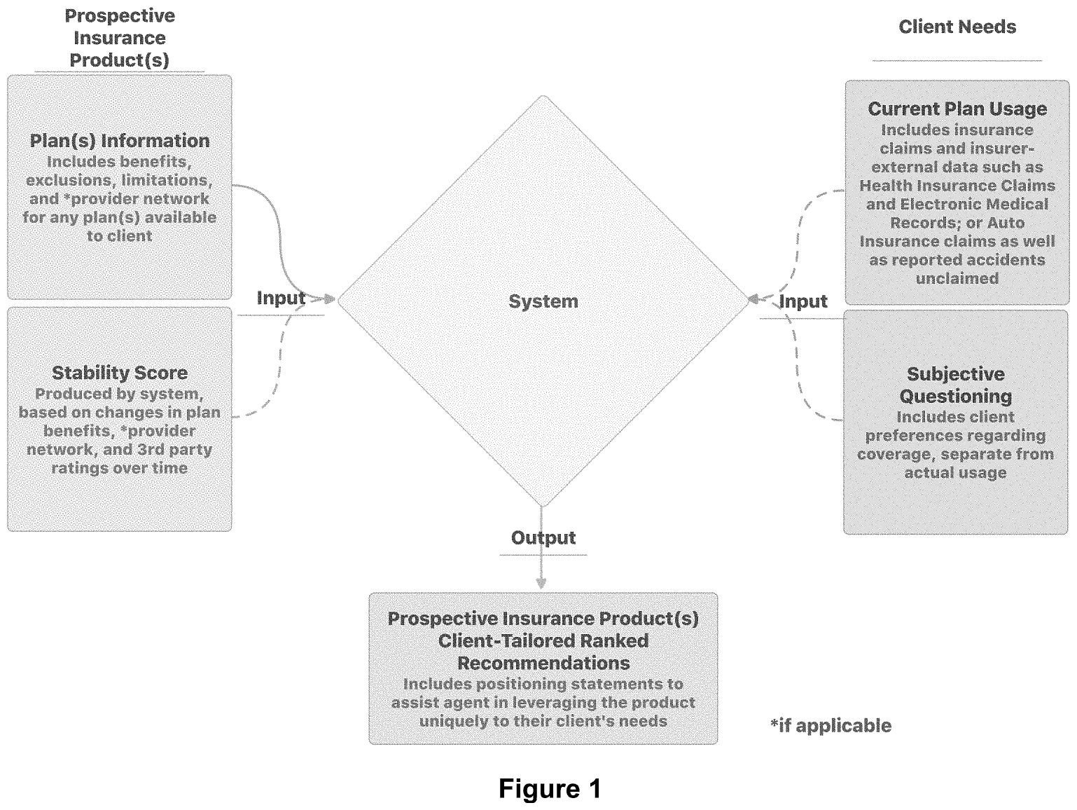

According to the block-diagram flow chart shown in FIG. 1, The system receives input from electronic medical records including but not limited to quantitative patient history available electronic exchanges such as Blue Button®, subjective (qualitative) questions that are either posed to the enrollee by a guided interview or entered directly into the system, insurance plan documents for a current year, and insurance plan documents for the preceding five years.

Examples of qualitative enrollee and patient healthcare preferences include but are not limited to geographic location of work, home, or school and relative proximity of providers, pharmacies, etc. thereto, the hours and invoicing methods of those providers, specific providers and specialists with whom enrollees or patients have existing relationships, provision of ancillary services such as patient transport, delivery of medications or DME, stocked brands, and tangible insurance features such as provider network size, importance of continuing to see current providers, deductibles, premiums, cost sharing, out of pocket maximums, value added benefits such as dental and vision.

In the initial input stages, the system both ascertains these preferences and asks the enrollee or patient to rank their importance relative to one another.

“Insurance Plan Documents” are official documentation of the function and operation of a given plan including but not limited to summaries of benefits, evidence of coverage, formulary, and provider directories. Many insurance companies make the most up-to-date version of these and other documents available electronically via API calls to their websites. These inputs are collected and analyzed by the system as described later in the present disclosure and then outputted to the agent as a list of plans annotated with positioning statements relevant to the enrollee.

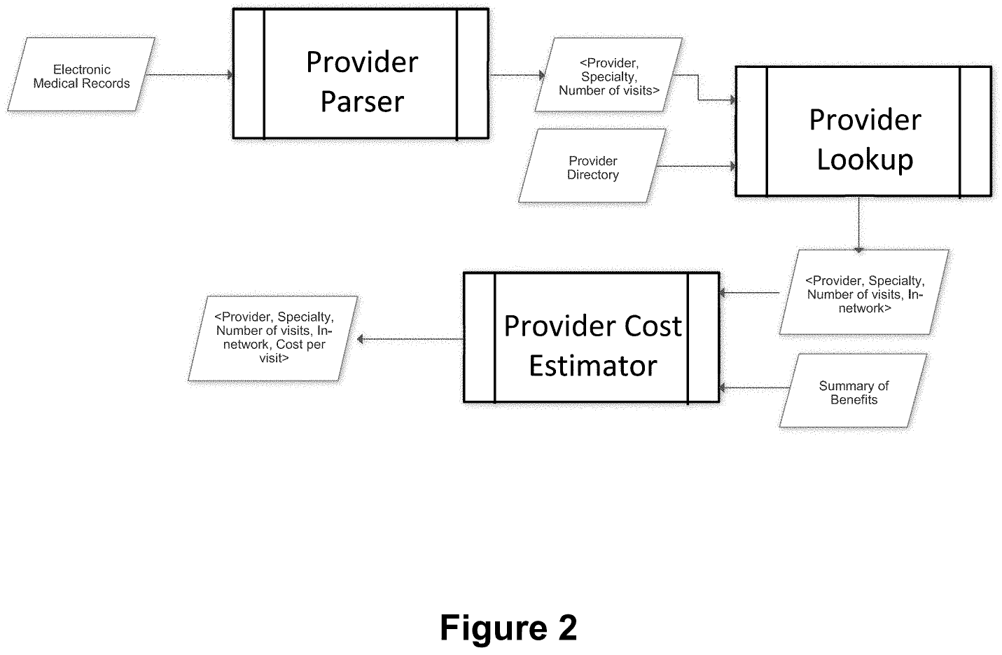

With reference to FIG. 2, an example processing flow for electronic medical records is shown. A “provider parser” collects information about the specific providers used by an enrollee in the preceding time window (for example 12 months). This provider list is then compared to the provider directory retrieved from various health insurance plans. The two lists are compared to cost estimates for the user both if they were to keep using their previous providers for each selected health insurance plan and for providers having similar geographic and time availabilities when providers from an enrollee's history are either out of network or past a selected cost-threshold per year. The results of this operation are reported as a “provider cost estimate” for each type of provider.

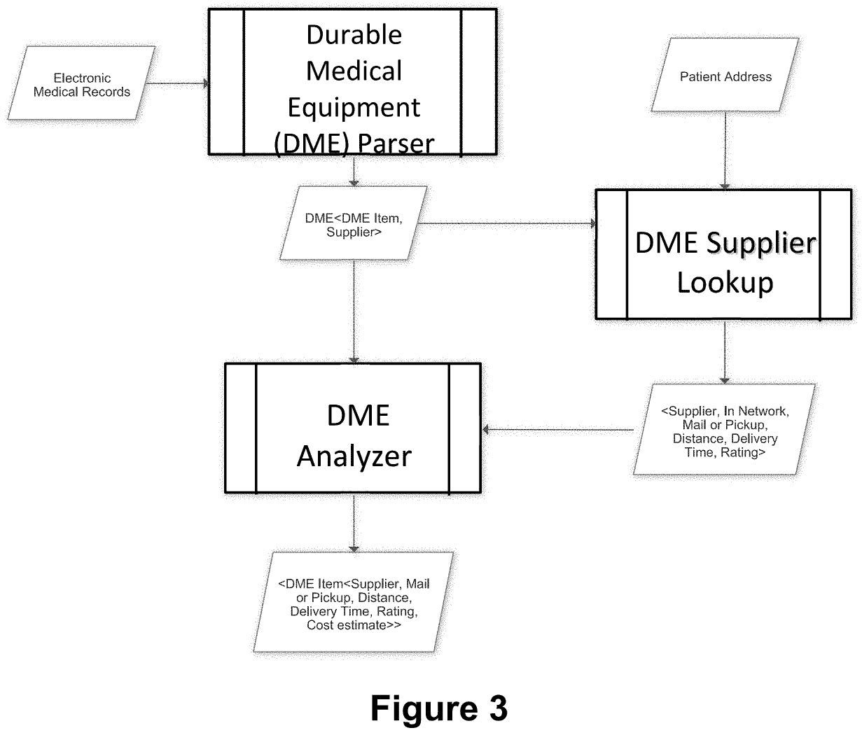

With reference to FIG. 3, an example processing flow for durable medical equipment (DME) records is shown. Here, previous one-time and recurring DME purchases by the enrollee are broken out by Item and Supplier. These are compared to available DME equipment for each available selected insurance plan as well as proximity to the patient's address. The output of this process shall be a listing of expected costs for interacting with the DME providers under a given plan as well as approximate delivery timing.

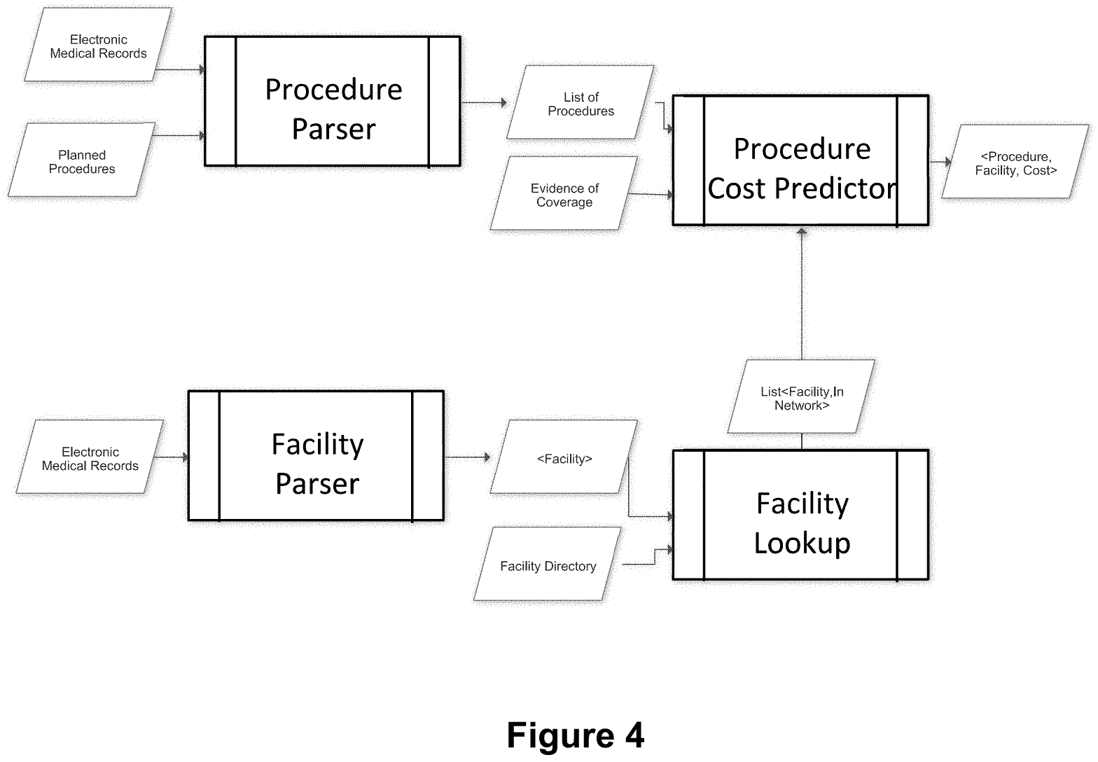

Referring now to FIG. 4, an example processing flow for procedures and facilities includes receiving an input from the electronic medical record past medical procedures and receiving from enrollee queries data about expected procedures.

Expected procedures as presently described can take 3 forms. In the first format, an enrollee or patient is asked explicitly whether they plan to have any procedures in the next 12 months. This may include elective procedures such as infertility treatments or contraceptive treatments that the patient or enrollee plans to undergo or procedures whose likelihood is inferred by the system because of the patient or enrollee's answers to life-event questions. For example, if an enrollee or patient answers that they are planning on having children soon, then the procedure parser will include costs and estimates for obstetric care, delivering a baby, and expected pediatric care within the first 12 months of a child's life. The final group of planned procedures considered by the system are those which are those determined to be likely based on the patient or enrollee's demographics and patient history when compared to a collective dataset of similar patients. For example, many patients receiving pain management and physical therapy for back pain eventually need lumbar fusion and patients with young children often require braces. For each given “planned” or “anticipated” procedure, the costs and facilities leveraged are calculated to provide a listing for the agent or user.

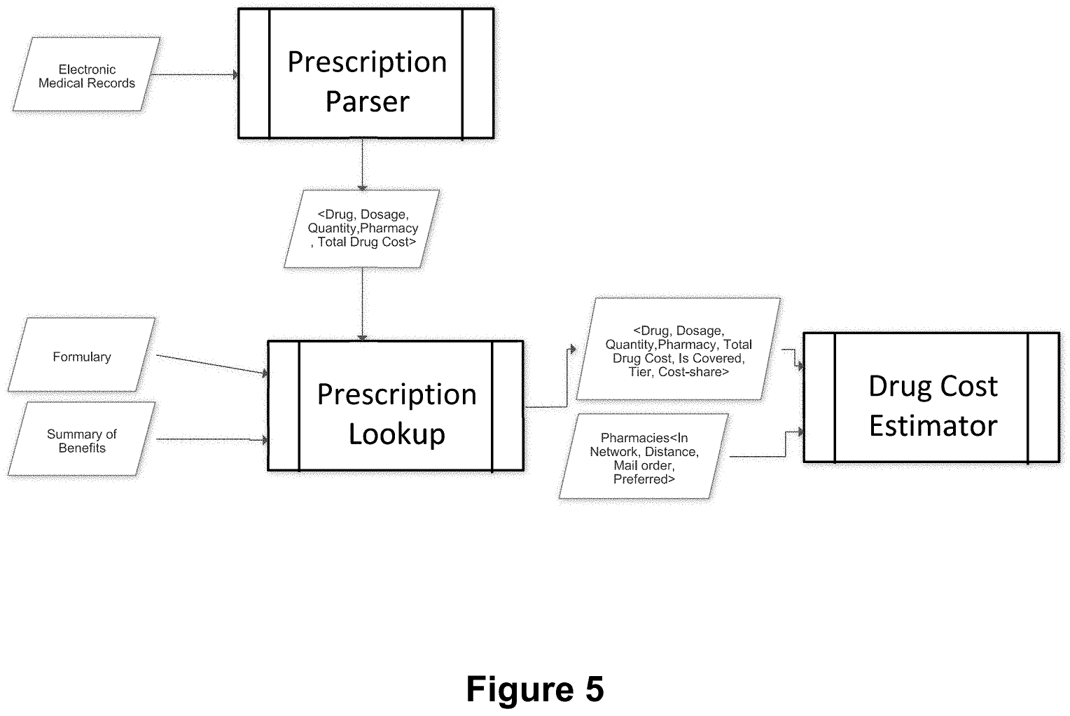

Referring now to FIG. 5, the electronic medical record for the enrollee is compared to the formulary and summary of benefits for each given insurance product and reported to the user or agent based on each drug, cost, and location of participating pharmacies.

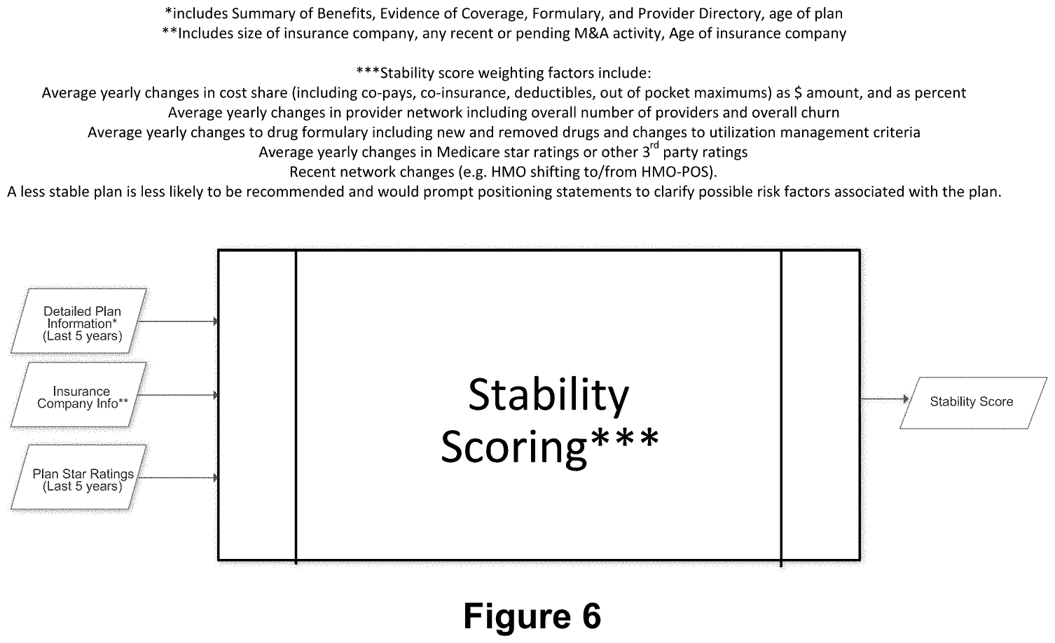

The preceding steps are used by the system to create a list of insurance plans whose offerings are a fit for the enrollee optimizing for cost, geographic convenience, and the providers who the enrollee has previously used or stated a preference for. Each of those resulting plans is scored for stability as shown in FIG. 6. Detailed plan information, insurance company info, and government star ratings are compared for both the breadth of offerings and how stable those offerings and details have been for an extended period of time ranging from the preceding 2 to 15 years. Detailed plan information includes but is not limited to summary of benefits, evidence of coverage, formulary, provider directories, and age of plans. Insurance company info includes but is not limited to size of the insurance company in terms of market capitalization, workforce data and trends, pending or recent M&A activity, company age, and ratings by business analysts. Plan star ratings are official scorings determined by Agencies of the United States Government on an annual basis.

These inputs are scored based on average yearly changes in cost share (including co-pays, co-insurance, deductible, out of pocket maximums) both as a dollar amount and as a change percentage, average yearly changes in provider network including overall number of providers and overall churn, average yearly changes to drug formulary including new and removed drugs and changes to utilization management criteria, yearly changes in government ratings including star ratings and the ratings determined by other 3^{rd} party agencies, recent network changes (for example HMO shifting to/from HMO-POS). Here, churn is a term of the art referring to the percentage of a provider group who leave a plan or network in a given year. Overall, if a plan is less stable (more prone to change), it may be ranked lower by the system and more likely to be presented to the user or agent with a description of the potential stability issues or history.

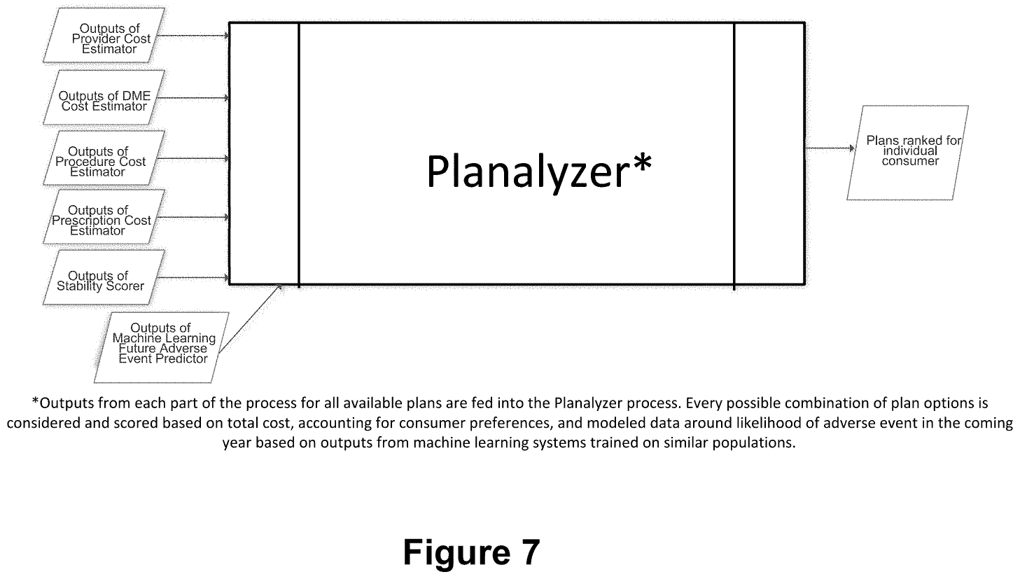

Referring now to FIG. 7, the logic flow for plan analysis module is shown. The outputs of the previously described provider cost estimator, DME cost estimator, procedure cost estimator, prescription cost estimator, and future event predictor are here entered into a matrix which compares all combinations of plans and options within those plans, scoring the result based on total cost, customer preferences, and plan stability to rank and order each plan on how good a fit it is for the enrollee and patient.

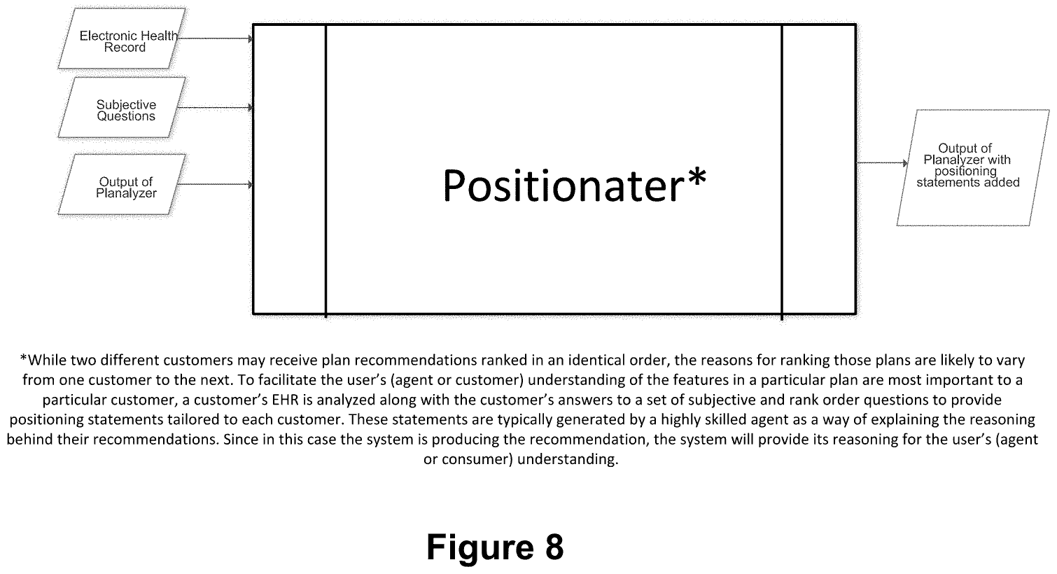

As shown in FIG. 8, these statements are arranged into natural language “positioning statements” in which the relative scores and ratings for each plan are described in terms of their relevance and impact upon the enrollee or patient.

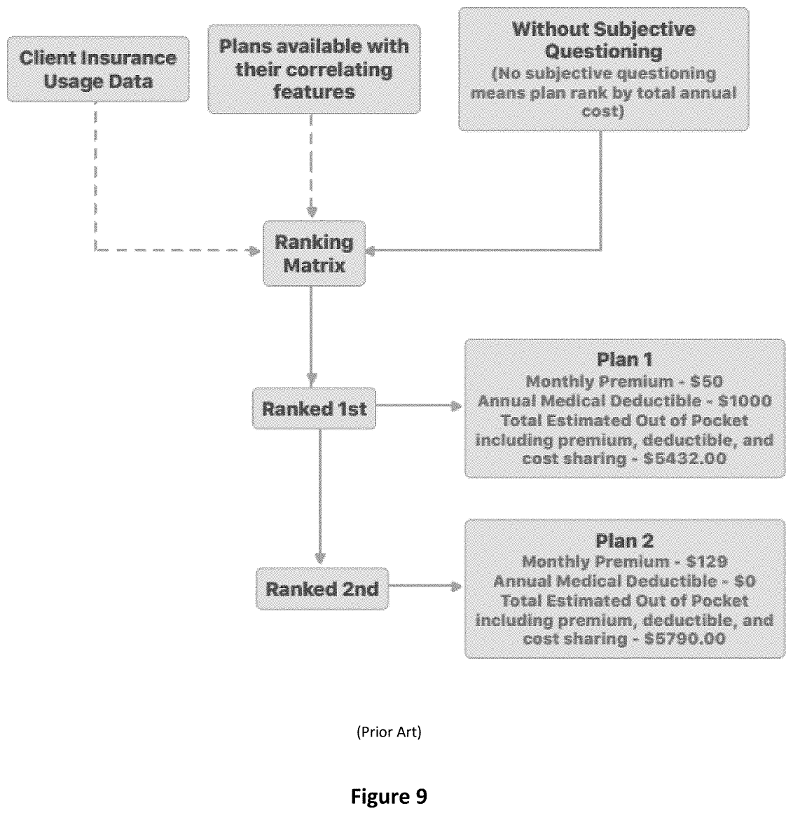

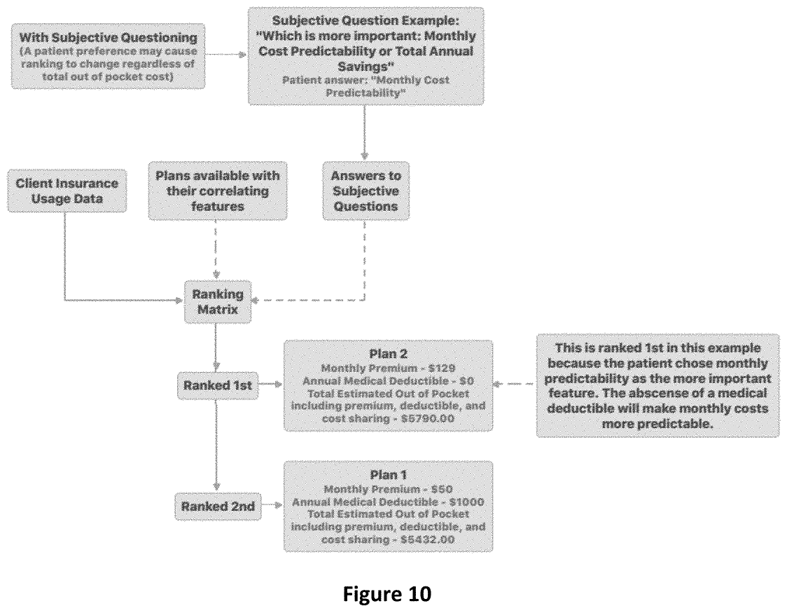

Referring now to FIG. 9, a current, prior art system for ranking insurance plan is shown where no subjective questioning as to enrollee priorities has been applied. A first plan, labelled “Plan 1” has a total estimated out of pocket expense of $5432 and is consequently ranked ahead of a second plan, labelled “Plan 2” which has a larger total estimated out of pocket expense of $5790. According to an aspect of the present system, as shown in FIG. 10, a user is inputs a response to a subjective question about the enrollee's preferences, specifically, that they prefer “Predictable Monthly Costs” to “Total Annual Savings.” In such a scenario, the overall more expensive second plan is ranked higher because its Monthly Premium is predictable whereas the Medical Deductible is not.

Examples of positioning statements are shown in the table below, specifically, benefit language is taken from the user's healthcare preferences or previous history to create an understanding in the user of how differences among healthcare options affect their costs and delivery of medical care.

| Product | | Linkage | |
|---|---|---|---|
| Feature | Feature Language | Language | Benefit Language |
| Premium | “This plan offers a $0 monthly | “so that” | “you only have to participate in the cost of |
| | premium . . . ” | | your coverage when you seek services |
| | | | through the plan.” |
| Deductible | “This plan only has a $250 | “so that” | “your benefits begin immediately once this |
| | deductible . . . ” | | amount is met.” |
| Co-pay | “This plan offers a $0 primary | “so that” | “no matter your health concern, you won't |
| | care physician copay . . . ” | | have any initial out-of-pocket costs when |
| | | | seeing the gatekeeper for your plan.” |
| Co- | “This plan offers 20% | “so that” | “the most you will have to pay in an |
| insurance | coinsurance for emergency | | emergency will be 20% of the plan's |
| | room services . . . ” | | contracted rate with the facility you visit.” |
| Network | “Your doctor, Dr. Smith, | “so that” | “you won't have to worry about |
| | accepts this plan as an in- | | unexpected costs or balance billing when |
| | network provider . . . ” | | seeking services from this provider.” |
| Formulary | “The medication you take is | “so that” | “all you'll have to pay is $4.00 for a 30 |
| | considered a Tier 1 Rx on this | | days supply.” |
| | plan's formulary . . . ” | | |
| 3rd Party | “{Reputable Rating Company | “so that” | “you can feel confident in choosing this |
| Rating | name} gives this plan an | | plan so long as it appropriately meets your |
| | overall score of {score} . . . ” | | personal needs.” |

In general, it will be apparent to one of ordinary skill in the art that at least some of the embodiments described herein can be implemented in many different embodiments or software and/or hardware. The software code can be executed by a processor or any other similar computing device. The software code or specialized control hardware that can be used to implement embodiments is not limiting. For example embodiments described herein can be implemented in computer software using any suitable computer software language type, using, for example, convention or object-oriented techniques. Such software can be stored on any type of suitable computer-readable medium or media, such as, for example magnetic or optical storage medium. The operation and behavior of the embodiments can be described without specific reference to specific software code or specialized hardware components. The absence of such specific references is feasible because it is clearly understood that artisans or ordinary skill would be able to design software and control hardware to implement the embodiments basic on the present description with no more than reasonable effort and without undue experimentation.

Moreover, the processes described herein can be executed by programmable equipment, such as computers or computer systems and/or processors. Software that can cause programmable equipment to execute processes can be used in any storage device, such as, for example, a computer system (non-volatile) memory, an optical disk, magnetic tape, or magnetic disk. Furthermore, at least some of the processes can be programmed with the computer system is manufactured or stored on various types of computer-readable media.

It can also be appreciated that certain portions of the processes described herein can be performed using instructions stored on a computer-readable medium or media that direct a computer system to perform the process steps. A computer readable medium can include, for example, memory devices such as diskettes, compact discs, digital versatile discs, optical disk drives, or hard disk driver. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant, wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments. The memory can also include any means for storing software, include a hard disk, an optical disk, floppy disk, ROM (read only memory), RAM (random access memory), PROM (programmable ROM), EEPROM (electrically erasable PROM) and/or other computer-readable media. Non-transitory computer-readable media, as used herein, comprises all computer-readable media except for transitory, propagating signals.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g. RAM or ROM) via one or more data buses. The data buses can carry electrical signals between the processor(s) and the memory. The processor and the memory can comprise electrical circuits, such as solid state transistors of the processor(s) and/or memory circuit(s); can change during operation of the circuits.

Some of the figures include a flow diagram. Although such figures can include a particular logic flow, it can be appreciated that the logic flow merely provides an exemplary implementation of the general functionality. Further, the logic flow does not necessarily have to be executed in the order presented unless otherwise indicated. IN addition, the logic flow can be implemented by a hardware element, a software element executed by a computer, a firmware element embedded in hardware, or any combination thereof.

The foregoing description of embodiments and examples has been presented for the purposes of illustration and description. It is not intended to be exhaustive or limited to the forms described. Numerous modifications are possible in light of the above teachings. Some of those modifications have been discussed and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention be defined by the claims appended hereto.

What is claimed is:

1. An interactive computer system for building a simultaneous display of two or more health insurance plans that reflect the character of an enrollee comprising providing a computer system which performs the steps of;
a. receiving from a user qualitative inputs regarding an enrollee's healthcare preferences;
b. receiving from a user qualitative inputs regarding the ranked relative importance of the elements from (a) for the enrollee;
c. receiving from an automated system quantitative inputs related to the user's prior or current behavior as it pertains to insurance usage;
d. receiving from an automated system quantitative inputs regarding regionally available healthcare plans;
e. receiving from an automated system healthcare plan documents for at least 2 preceding years for the plans listed in d;
f evaluating the documents from (e) for changes in at least two of previous years to at least two of cost share, provider network drug formulary, utilization management criteria, government ratings including star ratings, recent network changes;
g. generating, based on (f), relative stability scores for each plan;
h. generating, based on (a), (b), and (c) a set of criteria affecting the suitability of plans for a user;
i. generating a list based on the outputs of the (g) and (h), a list of plans suitable for a user as well as their respective stability scores.

2. The system of claim 1, wherein the user preferences from step (a) include at least two of, the medical providers used by an enrollee, requirements regarding utilitization management including at least one of prior authorization, quantity limits, step rules, and therapy requirements, pre and post treatment procedure guidelines, relationship of plan costs to deductibles, presence of pharmaceuticals or devices on an insurance formulary, plan treatment of predictable and unpredictable costs, level of engagement required by the enrollee for participation in plan features, and additional plan benefits.

3. The system of claim 1, wherein the quantitative inputs from step (c) include at least one of past claim or event data, healthcare providers utilized by the enrollee, healthcare services utilized by the enrollee, healthcare facilities utilized by the enrollee, and enrollee's financial information.

4. The system of claim 1, wherein the quantitative inputs regarding appropriate healthcare plans from step (d) include at least one of, participating provider data, plan costs, plan benefits.

5. The system of claim 1, further comprising dynamically generating descriptive language for each plan within the list in step (g), wherein the features of each plan are described to a user in terms responsive to at least one of, the user's stated preferences, impact that plan choice would have had on specific past events, and plan stability.

6. An interactive computer system for assisting a user to build a simultaneous display of two or more health insurance plans that reflects the character of an enrollee comprising providing a computer interface which performs the steps of;
a. receiving from a user qualitative inputs regarding the enrollee's healthcare preferences;
b. receiving from a user qualitative inputs regarding the ranked relative importance of the elements from (a);
c. receiving from an automated system quantitative inputs related to the enrollee's prior or current behavior as it pertains to insurance usage;
d. receiving from an automated system quantitative inputs regarding regionally available healthcare plans;
h. generating, based on (a), (b), and (c) a set of criteria affecting the suitability of plans for an enrollee;
i. generating a list based on the outputs of the (d), a list of plans suitable for a user as well as their respective stability scores;
j. generating based on (a), (c), and (i) natural language “positioning statements” that link plan features and benefits in terms of the enrollee and patient's actual usage and stated priorities.
